(19) United States
(12) Patent Application Publication
(10) Pub. No.: US 2012/0210559 A1
(43) Pub. Date: Aug. 23, 2012

(54) Method of manufacturing minimum weight thin wall profile members

(76) Inventor: Aleksandr Kamenomostskiy, New York, NY (US)

(21) Appl. No.: 13/317,871

(22) Filed: Oct. 31, 2011

Related U.S. Application Data
(63) Continuation-in-part of application No. 12/462,521, filed on Aug. 5, 2009, now abandoned.
Application No. 12/462,521 is a continuation of application No. 10/913,616, filed on Aug. 6, 2004, now abandoned.
Application No. 10/913,616 is a continuation of application No. 10/149,049, filed on Jun. 4, 2002, now abandoned.

(51) Int. Cl. B23P 17/04

(52) U.S. Cl. 29/592

(57) ABSTRACT

A method of manufacturing minimum weight thin wall profile members includes finding for the profile member a plurality of shape efficiency factors Σ₁, Σ₂ . . . Σₙ based on different values of ratios of dimensions within ranges, wherein each shape efficient factor is determined as;

Σ=K_{f}·Kₘ,
where:
   Kᵣ=(i²/F)^{2/5} is an overall stability factor
   Kₘ=K^{1/5}/(b/δ_{b})^{2/5}, is a local stability factor
   b, δ_{b}, are the width and the thickness of said main strip, respectively;
   i, F are the radius of gyration and the area of said cross section, respectively;
   K is the coefficient in the known formula for local stability critical stress, and manufacturing a profile member with the values of the ratios which resulted in the maximum shape efficiency factor, to ensure a reliable operation of the thin wall profile member with a minimum weight.

### CROSS-REFERENCE TO A RELATED APPLICATION

This application is a continuation-in-part of patent application Ser. No. 12/462,521 filed on Aug. 5, 2009 which is continuation of patent application Ser. No. 10/913,616 filed on Aug. 6, 2004, which is a continuation of patent application Ser. No. 10/149,049 filed on Jun. 4, 2002.

### BACKGROUND OF THE INVENTION

The present invention pertains to a method of manufacturing minimum weight thin wall profile members building structures with strict qualifying requirements to reliable operation and minimum weight of the structure.

Widespread types of structural units applied in building and in mechanical engineering are compressed thin wall structure members constituting thin wall profile members. They enable to meet strict operational requirements with respect to articles provided resolution of the “weight-strength” compromise, viz., stability and stiffness under compressive force provided minimization of weight. Minimization of the weight of thin wall structures encounters the issue of lack of a single dependence interconnecting multitude of parameters, in particular, critical stress, external load, material, dimensions and shape of cross section of a thin wall profile member.

Known thin wall profile members (hereinafter, TPM) are made with the shape and cross section dimensions constant along its length, for example, of a closed triangular or rectangular shape comprising main strip(s) and additional strip(s) with common reinforcing ribs [1]; [2, p. 33, FIG. 20]. The drawback of this known TPM is the narrow range of its applicability related to the restrictions brought about by its specific shape. Besides, the relations of dimensions of the cross section of this TPM are not optimal from the viewpoint of its weight minimization.

Other TPM are made with the shape and cross section dimensions constant along its length comprising main strip(s) and additional strip(s) with common reinforcing rib(s) and free reinforcing ribs. As TPM of such kind, the most common types of TPM can be considered, for example, I shaped, Z shaped, C shaped, T shaped, L shaped, etc, [3]; [4]; [2, p. 32, FIG. 18; p. 122, FIG. 111; p. 153, FIG. 142]. Embodiment of TPM of these shapes with the known ratios of cross section dimensions is not optimal either, regarding the weight minimization.

Also TPMs are made with the shape and cross section dimensions constant along its length comprising main strip(s) and additional strip(s) with common reinforcing ribs and free reinforcing rib(s) such as, for example, U shaped TPM, [5]; [6]; [7]; [8]; [2, p. 110 FIG. 101:, p. 111, FIG. 102].

During the manufacture of these TPMs with thus selected cross section dimensions [1-8], the effect of “spacing” of cross section material was not accounted for accurately enough: at higher moment of inertia, the respectively higher overall stability is achieved, while the local stability is thereby reduced. Due to this, it proves impossible to establish how close is the selected version of cross section dimensions to the one with the minimum area, hence with the minimum TPM weight.

### SUMMARY OF THE INVENTION

Accordingly, it is an object of the present invention to provide a method of manufacturing minimum weight thin wall profile members which is a further improvement of known methods. The proposed method pertains, in respect of the problem formulation, to the class of primal analytic problems: given load, material, pattern of axes and overall dimensions of the structure, dimensions of cross section shape (hereinafter, the shape dimensions) of members are found corresponding to the minimum weight of structures. The present method relating to the weight minimization problem is aimed at reduction of this number of parameters varied simultaneously, which cuts down the amount of calculations, eventually, reduces time and cost of design and development work.

In keeping with these objects and with others which will become apparent hereinafter, one feature of the present invention resides in a method of manufacturing a minimum weight thin wall profile member having comprising the steps of providing the cross section to include at least one of (1) at least two main strips and at least one additional strip having ends connecting with respective ends of two of said main strips, selecting dimensions such that said main strip has a thickness δ_{b} and a width b, said additional strip has a thickness δₐ, and a width a, and δ_{b}/b is no larger than δₐ/a, and (2) at least one main strip and at least one additional strip have one end connecting with an end of said main strip, said main strip has a thickness δ_{b} and a width b, said additional strip has a thickness δ_{c}, and a width c, and δ_{b}/b being no larger than δ_{c}/c; selecting ranges of ratios of values of dimensions for the profile member and several ratios within the ranges; determining, based on the several ratios a plurality of shape efficiency factors Σ₁, Σ₂ . . . Σₙ, wherein each the shape efficiency factors is determined as:

Σ=K_{f}·Kₘ,

where:
K_{f}=(i²/F)^{2/5} is an overall stability factor
Kₘ=K^{1/5}/(b/δ_{b})^{2/5}, is a local stability factor
b, δ_{b}, are the width and the thickness of said main strip, respectively;
i, F are the radius of gyration and the area of said cross section, respectively;
K is the coefficient in the known formula for local stability critical stress, depending on said ratios of cross sections [2]; finding within the plurality of the shape efficiency factors Σ₁, Σ₂ . . . Σₙ a maximum shape efficiency factor Σₘₐₓ; ascertaining values of the ratios for the profile member which resulted in determination of the maximum efficiency factor Σₘₐₓ; and manufacturing the profile member with the values of the ratios which resulted in the maximum shape efficiency factor for the profile member so as to ensure a reliable operation of the thin wall profile member with a minimal weight.

In accordance with another feature of the present invention the inventive method also includes, finding maximum shape efficiency factors for several profile members having different shapes, determining an overall maximum shape efficiency factor Σ₀ₘₐₓ from said maximum shape efficiency factors of all profile members, and manufacturing the profile member with the shape which has the overall maximum efficiency factor Σ₀ₘₐₓ.

In the present invention for the first time in order to manufacture thin wall profile members their local stability and their overall stability are determined and for the first time the local stability and the overall stability are utilized to determine a maximum shape efficiency factor of the profile members. The profile member which has a maximum shape efficiency factor will have the local stability and overall stability which are equal to each other, and will have a minimal weight, and it is selected and manufactured the known methods.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The method of manufacturing minimum weight thin wall profile members in accordance with the present invention is explained in connection with the figures, wherein for better understanding main strips and additional strips will be illustrated as main and additional webs and flanges. With this, a web strip possesses two common longitudinal reinforcing ribs, while the flange strip possesses one common longitudinal reinforcing rib and one free longitudinal reinforcing rib.

FIG. 1 shows TPM of the rectangular shape with two main webs and two additional webs;

FIG. 2 shows TPM of the triangular shape with two main webs and one additional web.

FIG. 3 shows the I shaped TPM with one main web and four additional flanges;

FIG. 4 shows the Z shaped TPM with one main web and two additional flanges;

FIG. 5 shows the C shaped TPM with one main web and two additional flanges;

FIG. 6 shows the T shaped TPM with one main flange and two additional flanges;

FIG. 7 shows the L shaped TPM with one main flange and one additional flange.

FIG. 8 shows the U shaped TPM with two main inclined webs, one additional web and two additional flanges;

FIG. 9 shows the diagram of the shape efficiency factor Σ versus the width of the main strip of the TPM (b).

The subject matter of the present inventions may best be understood by reference to the following descriptions taken in connection with the accompanying drawings. In FIG. 1 to 8, various shapes of TPM denoted by pos. 1, are shown, dimensions of which are selected in accordance with the recommended ratios stipulated in the present invention.

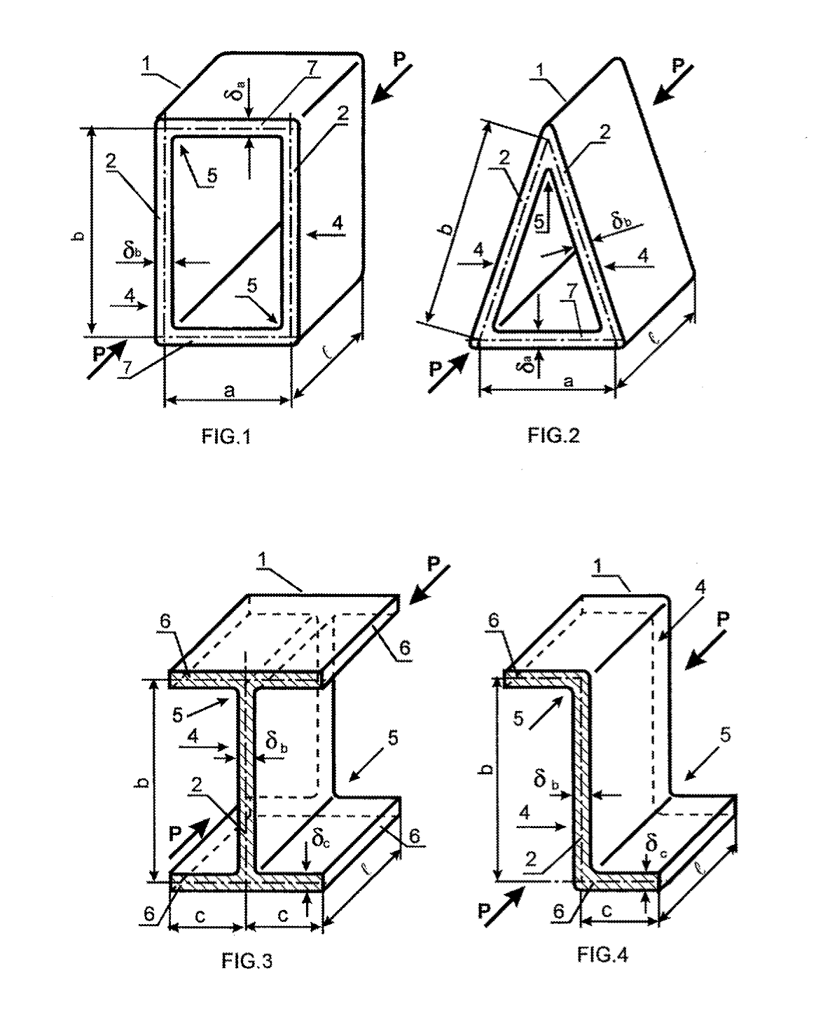

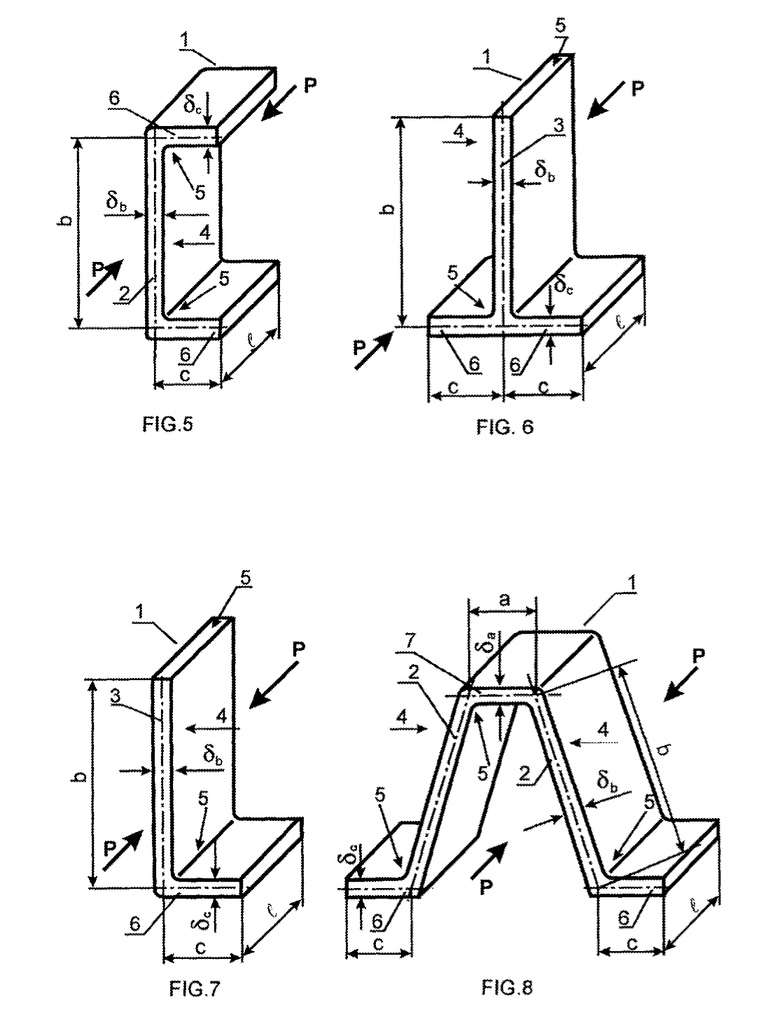

The TPM are intended for reacting the compressive load P and can be embodied, for example, as rectangular (FIG. 1), triangular (FIG. 2); I-(FIG. 3), Z-(FIG. 4), C-(FIG. 5), T-(FIG. 6), L-(FIG. 7), U-(FIG. 8) shapes.

TPM comprise the main web(s) 2 (FIGS. 1 to 5, 8); or main flange 3 (FIGS. 6, 7); embodied as main strip(s) 4, possessing two common longitudinal reinforcing ribs or one free longitudinal reinforcing rib and one common longitudinal reinforcing rib 5, respectively. Additional flange(s) 6 (FIG. 3 to 8) and web 7 (FIGS. 1, 2, 8) are embodied with the width less than that of the main strip 4 and with the thickness not less than that of the main strip 4.

With this, the stiffness of the main strip 4 does not exceed that of the additional strip (flanges 6, webs 7), specifically, δ_{b}/b is no larger than δₐ/a. And the stiffness of the additional strip with two common longitudinal reinforcing ribs, web 7 (FIG. 8), does not exceed the stiffness of the additional strip with one free longitudinal reinforcing rib and one common longitudinal reinforcing rib, flange 6 (FIG. 8), specifically, δₐ/a being no larger than δ_{c}/c.

The additional flange 6 or the additional web 7 can be located with respect to main strip 4 both at the angle 90° (FIGS. 1, 3 to 7) and at a different angle (FIGS. 2, 8).

Width and thickness of main webs 2, flanges 3 and additional webs 7, flanges 6 in the cross sections of TPM (FIGS. 1 to 8) satisfy expressions:

a/b=0.3 to 0.7; c/b=0.05 to 0.3; δₐ/δ_{b}=δ_{c}/δ_{b}=1.0 to 3.0,

where:
a, b, c, δₐ, δ_{b}, δ_{c} are, respectively, width and thickness of the additional web, the main web or flange and the additional flange.

The range of values of ratios of widths and ratios of thicknesses of main webs 2 and flanges 3, additional flanges 6 and webs 7 is obtained using the generalizing parameter with various shapes of TPM, which the author introduced and called the shape efficiency factor Σ:

Σ=K_{f}·Kₘ,

where:
Kᵣ=(i²/F)^{2/5} is an overall stability factor
Kₘ=K^{1/5}/(b/δ_{b})^{2/5}, is a local stability factor
b, δ_{b} are the width and the thickness of the main web 2 or flange 3, respectively;
i, F are the radius of gyration and the area of shape of TPM in FIG. 1 to 8, respectively;
K is the coefficient in the known formula for local stability critical stresses, depending on said ratios of TPM shape dimensions [2].

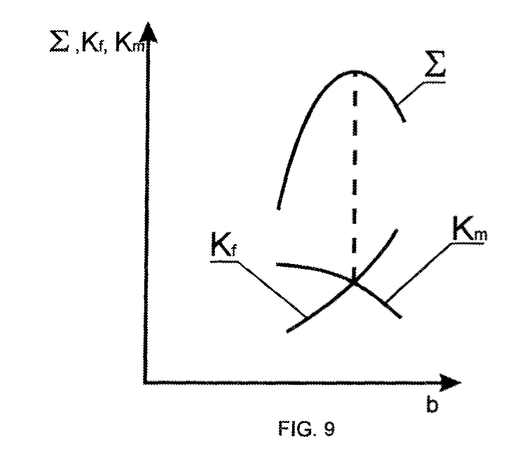

The graphic illustration of the shape efficiency factor Σ versus width of the main strip (b) is shown in FIG. 9. As one can see from this plot, the factor Σ possesses, for each shape, a maximum value. For various TPM shapes, these maximum values correspond to the ranges of ratios of dimensions. Various shapes of TPM can be compared in weight: the greater the maximum value of the factor Σ for a particular shape, the less is the TPM weight.

At the same time, within the specified ranges, maintaining the values of the above ratios, variation of shape absolute dimensions is possible which enables to provide for design/manufacturing restrictions not entailing a considerable increase of the weight of TPM. Beyond these ranges, the mass of TPM increases.

### DESCRIPTION OF THE PREFERRED EMBODIMENTS

A method of manufacturing minimum weight thin wall profile members in accordance with the present invention includes providing the profile members with at least one of (1) at least two main strips and at least one additional strip having ends connecting with respective ends of two of said main strips, selecting dimensions such that said main strip has a thickness δ_{b} and a width b, said additional strip has a thickness δₐ, and a width a, and δ_{b}/b is no larger than δₐ/a, and (2) at least one main strip and at least one additional strip have one end connecting with an end of said main strip, said main strip has a thickness δ_{b} and a width b, said additional strip has a thickness δ_{c}, and a width c, and δ_{b}/b being no larger than δ_{c}/c; choosing values of the ratios within, a range for each of the profile members having a corresponding one of said cross sections.

In accordance with the present invention, range of ratios of values of dimensions are selected for a profile member of each shape, and within the ranges of ratios for each profile member of each shape several values of ratios are selected.

Then for the profile member of the specific shape a plurality of shape efficiency factors Σ₁, Σ₂ . . . Σₙ, are determined with use of values of ratios within each range, wherein each shape efficiency factor, is:

Σ=K_{f}·Kₘ,

where:
Kᵣ=(i²/F)^{2/5} is an overall stability factor
Kₘ=K^{1/5}/(b/δ_{b})^{2/5}, is a local stability factor
b, δ_{b}, are the width and the thickness of said main strip, respectively;
i, F are the radius of gyration and the area of said cross section, respectively;
K is the coefficient in the known formula for local stability critical stresses, depending on said ratios of TPM shape dimensions [2].

From the plurality of the shape efficiency factors Σ₁, Σ₂ . . . Σₙ determined this way a maximum shape efficiency factor Σₘₐₓ is found. After this values of the ratios in the profile member, which resulted in determination of the maximum efficiency factor Σₘₐₓ; are ascertained.

Finally, the profile member with the values of the ratios which resulted in the maximum shape efficiency factor is manufactured by known methods. This ensures a reliable operation of the thin wall profile member with a minimal weight.

For the profile member which has one of (1) a hollow, generally rectangular-shaped cross section, with the longer sides of said rectangle comprising said main strips and each shorter side of said rectangle comprising said additional strip, and (2) a hollow, generally triangular-shaped cross section, with two sides of said triangle comprising said main strips and a third side of said triangle comprising said additional strip, the value of the range of the ratios is:

a/b=0.3 to 0.7 and δₐ/δ_{b}=1.0 to 3.0.

For the profile member which has a generally I-shaped cross section, with the upright portion of said I comprising said main strip and each of four flanges forming the top and base of said I comprising said additional strip, the value of the range of the ratios is:

c/b=0.05 to 0.3 and δ_{c}/δ_{b}=1.0 to 3.0.

For the profile member which has a generally Z-shaped cross section, with the upright portion of said Z comprising said main strip, a flange at an angle to said main strip forming the top of said Z comprising one said additional strip, and a flange at an angle to said main strip forming the bottom of said Z comprising a second said additional strip, the value of the range of the ratios is:

c/b=0.05 to 0.3 and δ_{c}/δ_{b}=1.0 to 3.0.

For the profile member which has generally C-shaped cross section, with the upright portion of said C comprising said main strip, a flange forming the top of said C comprising one said additional strip, and a flange forming the bottom of said C comprising a second said additional strip, the value of the range of the ratios

c/b=0.05 to 0.3 and δ_{c}/δ_{b}=1.0 to 3.0.

For the profile member which has a generally T-shaped cross section, with the upright portion of said T comprising said main strip and each of two flanges forming the top of said T comprising said additional strip, the value of the range of the ratios is:

c/b=0.05 to 0.3 and δ_{c}/δ_{b}=1.0 to 3.0.

For the profile member which has member a generally L-shaped cross section, with the upright portion of said L comprising said main strip and a flange forming the bottom of said L comprising said additional strip; the value of the range of the ratios is:

c/b=0.05 to 0.3 and δ_{c}/δ_{b}=1.0 to 3.0.

For the profile member which has a generally U-shaped cross section with the sides of said U comprising said main strip, the bottom of said U comprising said additional strip, and flanges extending from the ends of the legs of said U comprising two said additional strips, the value of the range of the ratios is:

a/b=0.3 to 0.7 and δₐ/δ_{b}=1.0 to 3.0; and

c/b=0.05 to 0.3 and δ_{c}/δ_{b}=1.0 to 3.0.

An example of designing and manufacturing of the thin wall profile member with a generally I shaped cross section is presented herein below.

The ranges of ratios for I shaped profile member are c/b=0.05 to 0.3 and δ_{c}/δ_{b}=1.0 to 3.0. From these ranges the following variants of values of the ratios are selected:

| Variant | 1 | 2 | 3 | 4 | 5 |
|---|---|---|---|---|---|
| c/b | 0.05 | 0.15 | 0.2 | 0.4 | 0.4 |
| δ_{c}/δ_{b} | 2.5 | 2.0 | 1.0 | 0.5 | 3.3 |

For I shaped profile member and the selected variants values of ratios, values of the shape efficiency factors are as follows:

Σ₁=0.556, Σ₂=0.538, Σ₃=0.513, Σ₄=0.415, Σ₅-=0.379 respectively.

It can be seen that values of Σ₄ and of Σ₅ based on ratios outside the range are significantly less.

It can be further seen from Σ₁, Σ₂, Σ₃, based on the ratios within the range the shape efficiency factor Σ₁ has a maximum value.

It was obtained from the ratios c/b=0.05 δ_{c}/δ_{b}=2.5.

Then the I shaped thin wall profile member with these ratios is manufactured by known methods.

The ranges of ratios of dimensions for the thin wall profile members of each shape are selected so that all shape efficiency factors based on ratios of dimensions of each range do not differ significantly from the maximum efficiency factor for this shape within the range.

In accordance with a further embodiment of the invention for selecting the most efficient profile member with minimum weight from the profile members of different shapes, a plurality of maximum shape efficiency factors Σₘₐₓ1, Σₘₐₓ2 . . . ΣₘₐₓN, are determined for all profile members of different shapes, an overall maximum shape efficiency factor Σ₀ₘₐₓ is determined from said maximum shape efficiency factors of the profile members of different shapes, and the profile members of that shape is manufactured which has the overall maximum shape efficiency factor Σ₀ₘₐₓ.

It will be understood that each of the elements described above, or two or more together, may also find a useful application in other types of methods differing from the type described above.

While the invention has been illustrated and described as embodied in a method of manufacturing thin wall profile members, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

### REFERENCES

1. U.S. Pat. No. 4,912,903, E04C 3/04, Apr. 3, 1990
2. Hertel, H, Thin wall structures.—Moscow, “Mashinostroyeniye”, 196E 527 p. [in Russian; translation from: Hertel, H, Leichtbau: Bauelemei Bemessungen and Konstruktionen von Flugzeugen and ande Leichtbauwerken. û Springer-Verlag, Berlin]
3. WO 92/09767, EO4C 3/04, Jun. 11, 1992
4. U.S. Pat. No. 5,518,208, B64C 1/06, May 21, 1996
5. WO 91/05925, E04C 2/08, May 2, 1991.
6. U.S. Pat. No. 5,842,318, E04C 3/07, Dec. 1, 1998
7. WO 96/30606, E04C 3/07, 3/09, 3/292, Oct. 3, 1996
8. WO 00/17463, E04C 3/07, Mar. 30, 2000

1. A method of manufacturing a thin wall profile member comprising the steps of providing a cross section to include at least one of (1) at least two main strips and at least one additional strip having ends connecting with respective ends of two of said main strips, selecting dimensions such that said main strip has a thickness δ_{b}, and a width b, said additional strip has a thickness δₐ and a width a, and δ_{b}/b is no larger than δₐ/a, and (2) at least one main strip and at least one additional strip have one end connecting with an end of said main strip, said main strip has a thickness δ_{b} and a width b, said additional strip has a thickness δ_{c}, and a width c, and δ_{b}/b being no larger than δ_{c}/c; selecting ranges of ratios of values of dimensions for the profile member and various values of ratios within the ranges; determining for each of the profile members a plurality of shape efficiency factors Σ₁, Σ₂ . . . Σₙ, wherein each the shape efficiency factors is determined as
Σ=K_{f}·Kₘ,
where:
K_{f}=(i²/F)^{2/5} is an overall stability factor
Kₘ=K^{1/5}/(b/δ_{b})^{2/5}, is a local stability factor
b, δ_{b}, are the width and the thickness of said main strip, respectively;
i, F are the radius of gyration and the area of said cross section, respectively;
K is the coefficient in the known formula for local stability critical stress; finding within the plurality of the shape efficiency factors Σ₁, Σ₂ . . . Σₙ for each profile member a maximum shape efficiency factor Σₘₐₓ; ascertaining values of the ratios for the profile member which resulted in determination of the maximum efficiency factor Σₘₐₓ; and manufacturing of the profile member with the values of the ratios which resulted in the maximum shape efficiency factor for the profile member so as to ensure a reliable operation of the thin wall profile member with a minimal weight.

2. The method of claim 1, wherein said choosing includes, for said member which has one of (1) a hollow, generally rectangular-shaped cross section, with the longer sides of said rectangle comprising said main strips and each shorter side of said rectangle comprising a said additional strip, and (2) a hollow, generally triangular-shaped cross section, with two sides of said triangle comprising said main strips and a third side of said triangle comprising said additional strip, the value of these ranges of the ratios:
a/b=0.3 to 0.7 and δₐ/δ_{b}=1.0 to 3.0.

3. The method of claim 1, wherein said choosing includes, for said member which has a generally I-shaped cross section, with the upright portion of said I comprising said main strip and each of four flanges forming the top and base of said I comprising said additional strip, the values of the ranges of the ratios:
c/b=0.05 to 0.3 and δ_{c}/δ_{b}=1.0 to 3.0.

4. The method of claim 1, wherein said choosing includes for said member which has a generally Z-shaped cross section, with the upright portion of said Z comprising said main strip, a flange at an angle to said main strip forming the top of said Z comprising one said additional strip, and a flange at an angle to said main strip forming the bottom of said Z comprising a second said additional strip, the values of the ranges of the ratios:
c/b=0.05 to 0.3 and δ_{c}/δ_{b}=1.0 to 3.0.

5. The method of claim 1, wherein said choosing includes for said member which has generally C-shaped cross section, with the upright portion of said C comprising said main strip, a flange forming the top of said C comprising one said additional strip, and a flange forming the bottom of said C comprising a second said additional strip, the values of the ranges of the ratios:
c/b=0.05 to 0.3 and δ_{c}/δ_{b}=1.0 to 3.0.

6. The method of claim 1, wherein said choosing includes, for said member which has a generally T-shaped cross section, with the upright portion of said T comprising said main strip and each of two flanges forming the top of said T comprising said additional strip, the values of the ranges of the ratios:
c/b=0.05 to 0.3 and δ_{c}/δ_{b}=1.0 to 3.0.

7. The method as defined in claim 1, wherein said choosing includes, for said which has member a generally L-shaped cross section, with the upright portion of said L comprising said main strip and a flange forming the bottom of said L comprising said additional strip; the values of the ranges of the ratios:
c/b=0.05 to 0.3 and δ_{c}/δ_{b}=1.0 to 3.0.

8. The method of claim 1, wherein said choosing includes for said member which has a generally U-shaped cross section with the sides of said U comprising said main strip, the bottom of said U comprising said additional strip, and flanges extending from the ends of the legs of said U comprising two said additional strips, the values of the ranges of the ratios:
a/b=0.3 to 0.7 and δₐ/δ_{b}=1.0 to 3.0; and
c/b=0.05 to 0.3 and δ_{c}/δ_{b}=1.0 to 3.0.

9. The method of claim 1, further comprising determining a plurality of maximum efficiency factors for a plurality of profile members having different shapes; selecting from the plurality of maximum shape efficiency factors Σₘₐₓ1, Σₘₐₓ2 . . . ΣₘₐₓN of profile members having different shapes an overall maximum efficiency factor Σ₀ₘₐₓ, and making the profile member of that shape which has the overall maximum efficiency factor Σ₀ₘₐₓ.
